(19) United States
(12) Patent Application Publication
(10) Pub. No.: US 2026/0147323 A1
(43) Pub. Date: May 28, 2026

(54) ASYMMETRICAL METHOD TO COMPENSATE QUANTIZATIONS OF CONTROL LOOP ACTUATORS

(71) Applicant: Petróleo Brasileiro S.A. - Petrobras, Rio de Janeiro (BR)

(72) Inventor: Luis Gustavo SOARES LONGHI, Canoas (BR)

(73) Assignee: Petróleo Brasileiro S.A. - Petrobras, Rio de Janeiro (BR)

(21) Appl. No.: 19/397,664

(22) Filed: Nov. 21, 2025

(30) Foreign Application Priority Data
Nov. 28, 2024 (BR) 1020240248368

(51) Int. Cl. G05B 13/04

(52) U.S. Cl. CPC G05B 13/042

(57) ABSTRACT

Please substitute the following paragraph(s) for the abstract now appearing in the currently filed specification:
Disclosed is a method for compensating for seizure in valves/actuators in industrial control loops whose quantization results in oscillation. The controller signal passes through a compensator before reaching the actuator. At each sampling time, the signal is compared with operating band (BOP) and seizure size (D). If the variation is within the BOP, the signal is unchanged. If the variation is ≥D, it is sent to the actuator. When the variation exceeds BOP but is <D, variation plus D is sent to the actuator. The controller waits for actuator response time (TRA) sufficient for the actuator to move. At the end of the TRA, a counter-directional signal composed of D times an asymmetric factor (FA) drives opposite motion, allowing the actuator to reach suitable position. BOP is repositioned per the new actuator value, and the cycle repeats, enabling the actuator to achieve intermediate position within acceptable error.

### CROSS-REFERENCE TO RELATED APPLICATIONS

This application claims priority to Brazilian Patent Application No. 10 2024 024836 8, filed Nov. 28, 2024, the entire contents of which is incorporated herein by reference.

### FIELD OF THE DISCLOSURE

The present invention relates to the field of process control in industrial plants. More specifically, the present invention relates to a more efficient method for compensating the quantization effect due to static friction in the final control elements, thus preserving their useful life.

### BACKGROUND OF THE DISCLOSURE

Control valves are mechanical elements that experience friction when their stem moves. The stem is typically moved pneumatically (compressed air) in response to a signal sent by a remote controller (computer). The main problem is that when the actuation signal is inverted (closing instead of opening and vice versa), the signal (air) accumulates until the friction is overcome, leading to a quantization of the positions the actuator can assume. In short, depending on the size of the air signal sent, the stem does not move. Since PID (Proportional-Integral-Derivative) controllers, which represent almost all basic control methods, are designed without considering this quantization, if static friction is relatively high, which is very common in industrial settings, an effect called “sticion” (static friction) or actuator sticking/seizure occurs. This leads to oscillations in the controlled variable, as when the air overcomes the friction, it pushes the actuator to a position beyond the required position (overshoot or raised level), causing the control to act in the opposite direction, repeating the overshoot and generating oscillations that impair process performance and reduce actuator life. This effect is very common and is easily identified with CLPM (Control Loop Performance Monitor) tools or even historical operating data.

Control loops that have sticking/seizure operate oscillating when closed (automatic mode), as can be seen in FIG. 1 of the prior art. In FIG. 1, the abscissa represents time (in seconds), and the ordinates represent the controlled variable in the upper graph and the controller output in the lower graph. The oscillation in process variable 80 occurs because the signal sent by the controller to actuator 90 does not move the actuator until it overcomes static friction. When this happens, the position of the actuator goes beyond what is necessary to adjust the controlled variable due to the accumulation of the signal, causing overshoot. This leads the controller to send a signal in the opposite direction to adjust the controlled variable again, which also does not respond until it overcomes friction, generating a sawtooth-like movement in the controller output (signal sent to the actuator) and causing oscillation in the controlled variable and the control system as a whole. If the lockout is too large, it is common for the loop to operate manually, which leads to performance and safety losses due to the lack of process control, which is the first layer of safety in industrial plants.

### STATE OF THE ART

The document “Use of native digital features to transform a PID into a noise-insensitive algorithm that mimics human action” (Luís Gustavo Soares Longhi, Rio Oil & Gas Expo and Conference, 2022) discloses a PID algorithm adapted for noise and seizure compensation in industrial control loops. This algorithm uses the modulation rate and deadband parameters of the PV of the loop.

The document U.S. Pat. No. 6,286,532 B1, entitled “Control system and method for controlling valves,” discloses a control system and a method for controlling a valve closure member that compensates for hysteresis caused by static friction and/or Coulombic friction. In particular, the control system and method can be used to control any type of valve closure member, including linearly actuated valve closure members and rotary actuated valve closure members. A method for controlling a valve closure member according to D1 includes the steps of determining a control value indicative of an uncompensated target position of the closure member. The method further includes the step of calculating a friction compensation value associated with the closure member. The friction compensation value may comprise a static friction compensation value or a coulombic friction compensation value. The friction compensation value may be used to increase or decrease a compensation control value and an associated compensation control signal to compensate static friction and/or coulombic friction. The method further includes the step of calculating the compensation control value responsive to the control value and the friction compensation value. Finally, the method includes the step of actuating the closure member responsive to the compensation control value.

The document IN 202221043726, entitled “Method and system for optimizing proportional valve response”, discloses a method (600) for optimizing the response of the proportional actuator. The method (600) may include receiving an actuation signal input to a proportional valve actuator (102) and receiving a return signal from a flow sensor (108) corresponding to a response of the proportional valve actuator (102) to the actuation signal. The flow sensor (108) may be positioned at an output gate of the proportional valve actuator. The method may further include analyzing the actuation signal and the return signal to determine a time delay associated with the response of the proportional valve actuator (102) and determining a transfer function associated with the proportional valve actuator. The method may further include determining, using a predictive model, a correction factor for the response of the proportional valve actuator, based on the time delay and the transfer function, to optimize the response of the proportional actuator.

The document WO 1997011297 A1, entitled “Method and control system for compensating friction”, discloses a method for compensating static friction in an actuating means comprising the steps of generating a real-valued signal y2(t) corresponding to a quantity that is controllable by the actuating means, generating a defined-valued signal y2(t), generating a control signal s1(t) based on the defined-valued signal y1(t) and the real-valued signal y2(t), and supplying the control signal to the actuating means to control it. The method also comprises the steps of generating an intermittent signal s2(t) compensating friction, detecting the sign of the derivative with respect to time of the control signal s1(t), giving the signal s2(t) compensating friction the same sign as said derivative, and adding the signal s2(t) compensating friction to said control signal s1(t) before supplying it to the actuating means.

### SUMMARY OF THE DISCLOSURE

The present invention discloses an improved compensation method to ensure actuator movement in an industrial plant based on two parameters: the return time of the actuator and the asymmetry factor of the actuator. These changes ensure the actuator moves and reaches the desired position without oscillations. The method acts on the PID itself, adding a signal that overcomes the seizure (of the estimated quantization size), waits for the response of the actuator, and then adds an asymmetric return signal to move the actuator back to a suitable position. This asymmetric increment ensures actuator movement and overcomes the disadvantages of the known methodology of adding back the seizure itself, which does not always move the actuator. It is necessary to overcome this barrier with an asymmetry factor. Likewise, it is necessary to allow time for the valve to move by inserting a compensator response time different from the execution time of the controller. This parameter, linked to the dynamic aspect of the actuator, did not exist in the original method and is ignored in other patented solutions and in the open literature.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The present invention will be described below with reference to its typical embodiments and also with reference to the accompanying drawings.

FIG. 1 is a graph illustrating the effect of static friction on control loops from the state of the art.

FIG. 2 graphically illustrates the control method according to the present invention.

FIG. 3 illustrates a schematic block diagram of a static friction compensation system according to the present invention.

FIG. 4 illustrates an operating screen of a control loop implementing the method according to the present invention.

FIG. 5 illustrates a faceplate of the FIC-5036 control loop implementing the method according to the present invention.

FIG. 6 illustrates a faceplate detailing the loop of FIG. 5.

FIG. 7 illustrates a FIC-5036 loop control module with the compensator implementing the method according to the present invention.

FIG. 8 illustrates a FIC-5036 control loop operating in accordance with the state of the art.

FIG. 9 illustrates a FIC-5036 control loop operating with the compensator implementing the method according to the present invention.

FIG. 10 illustrates data from the CLPM tool for a control loop operating in accordance with the state of the art.

FIG. 11 illustrates data from the CLPM tool for a control loop operating with the compensator implementing the method according to the present invention.

FIG. 12 illustrates a control loop operating in accordance with the state of the art.

FIG. 13 illustrates a control loop operating with the method according to the present invention.

### DETAILED DESCRIPTION OF THE DISCLOSURE

Specific embodiments of the present disclosure are described below. In an effort to provide a concise description of these embodiments, all features of an actual implementation may not be described in the specification. It should be appreciated that in the development of any actual implementation, as in any engineering or design project, numerous specific implementation decisions must be made to achieve the specific objectives of the developers, such as compliance with system-related and business constraints, which may vary from one implementation to another. Furthermore, it should be appreciated that such a development effort can be complex and time-consuming but would nevertheless be a routine design and manufacturing undertaking for those of ordinary skill having the benefit of this disclosure.

The effect caused by static friction in the final control elements of industrial plants is known in the art as binding or seizure. For simplicity, in this description, the term seizure will be used, without distinguishing it from the term locking, to describe this phenomenon. Static friction will also be referenced when referring to this force.

Similarly, the final control elements of industrial plants will be referred to here as actuators. The most common actuators are control valves, and they may be referred to here in particular or preferred applications of the present invention.

The present invention is directed to techniques for compensating static friction in industrial control loops. In general, the most critical static frictions are well known and quantified by control engineers. There are several works on static friction in the literature, among which CHOUDHURY, M. S. ; JAIN, M. ; SHAH, S. L. “Stiction-definition, modeling, detection and quantification” (Journal of Process Control, Elsevier, volume 18, number 3, pages 232 to 243, 2008) stand out.

On the other hand, there are few studies on static friction compensation (or stiction compensation). Static friction is one of the main causes of degradation in control loop performance. Some studies indicate that between 20 and 30% of loops have problems resulting from this phenomenon. Most published methods are limited to detecting and quantifying stiction. A reference in this regard is GARCIA, C. Comparison of friction models applied to a control valve (Control Engineering, Practice, Elsevier, volume 16, number 10, pages 1231 to 1243, 2008). Another important reference is HAGGLUND, T. A friction compensator for pneumatic control valves (Journal of Process Control, Elsevier, volume 12, number 8, pages 897 to 904, 2002), which gave rise to the compensator known as a knocker, the subject of prior art WO 1997011297 A1 described above. Although effective, the knocker has the notorious disadvantage of causing accelerated wear on devices due to aggressive changes in signal direction.

This method proposes a smoothed approach, respecting the natural response time of the actuator or valve to the signal from the controller.

Referring to FIG. 2, the signal sent by the controller (10) passes through the compensator before being sent to the actuator. The signal that leaves the compensator (20) is the one actually sent to the actuator. The signal sent by the controller (10) is a discrete (digital) signal, shown by the black dots at each controller sampling time. At each sampling, the signal is compared with the operating band or BOP (30) and with the size of the seizure or D (40). If the variation in the controller signal is within the BOP, the signal (20) is unchanged. If the variation is equal to or greater than D, it is sent in full to the actuator, as it has the capacity to overcome the seizure. If the signal variation extends beyond the BOP and is less than D, this variation is added to D and sent to the actuator. Then, the controller waits for a sufficient actuator response time or TRA (50) for the actuator to move, which is defined in sampling intervals (in the case of FIG. 2, three samples). At the end of the TRA, a counterclockwise signal, composed of D multiplied by an asymmetric factor or FA (60), is implemented. The FA should be slightly greater than 1 to ensure that the return movement overcomes static friction, with suggested values between 1.05 and 1.25. Values higher than these should be avoided to prevent the return from exceeding the initial movement (overshoot or superelevation). A return slightly above the grab value ensures that the actuator will move in the opposite direction and find a suitable position. At that same time, the BOP is repositioned (70) according to the new actuator position, and the cycle repeats. Thus, the actuator moves and finds an intermediate position with an acceptable error defined by the BOP itself. The acceptable error value is a value close to the smallest error between the setpoint and the process variable that provides control without oscillation. It can be quantified by the standard deviation of the process variable, which is a good measure of the noise (non-deterministic portion) of the measured signal.

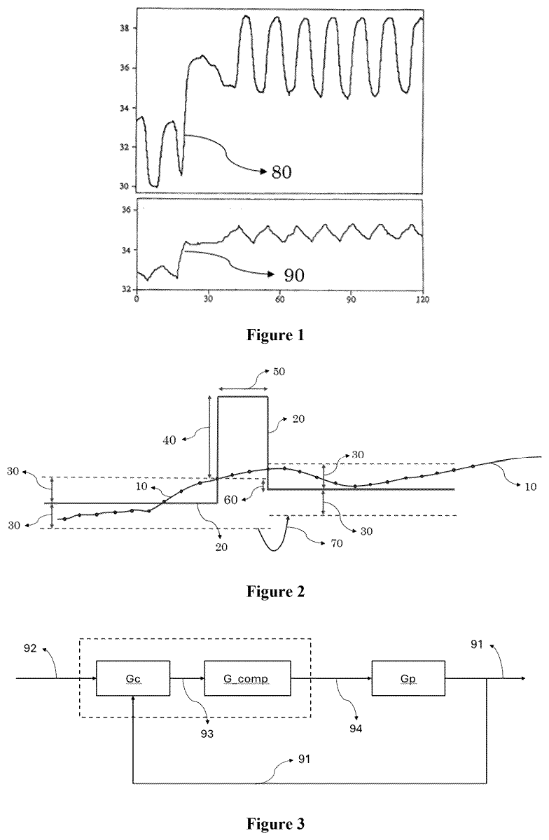

The method described here acts on the output signal of the controller, which, instead of being sent directly to the actuator, passes through the compensator first, according to the logic in FIG. 2. The signal that leaves the compensator is the one actually sent to the actuator, which is a real physical element, as can be seen schematically in FIG. 3. In the block diagram of FIG. 3, the controlled process variable (91) is measured in the industrial plant (Gp) and sent (via return) to the controller (Gc). The controller compares this value with the desired value for the controlled variable (92) and calculates the actuator position (93) to achieve this objective. A conventional control loop would send this value directly to the process, where the actuator is located. In the present invention, the signal (93) is sent to the compensator (G_comp), which performs the necessary processing to compensate the seizure, sending the processed value (94) to the actuator, which is part of a process loop (Gp) so as to avoid the consequences shown in FIG. 1.

A sensor measures the controlled variable and sends it to the control module in the control and monitoring system. The invention is implemented within this module, in the control and monitoring system, and allows a reliable signal to be sent to the actuator, allowing the unit to operate with cost-effective and safe control rather than oscillatory or unsafe control (in the case of not operating in automatic mode due to inability to handle the seizure).

The developed method has the sequential steps described below. The initial condition is assumed to be the control loop operating in automatic mode without the compensator activated. Also consider that the sampling interval is constant and defined by the difference between two sequential scan (reading) times. The output value of the controller is OP (output), and the value sent to the actuator after passing through the compensator is OPC (compensated output). There is also an auxiliary Boolean flag, called RETURN, which indicates to the method whether it is necessary (1) or not (0) to perform the return movement shown in FIG. 2.

### 1. Definition Of Method Input Values

a. Estimated seizure (D) in %.
b. Actuator Response Time (ART), in sampling intervals.
c. Operating Bandwidth (BOP) in %.
d. Asymmetric Factor (AF), in an extra % of D.

### 2. Activation

a. The compensator is activated (turned on by the method) by the operator at the HMI (Human Machine Interface) via the controller module of the control system.

### 3. Initialization

a. When turned on, the compensator records the current value of the controller output (OP) at the compensator output (OPC) and sends it to the actuator, i.e.: OPC=OP. At this point, the RETURN flag value is zero.

### 4. From the Second Sampling Time on, at Each Compensator Scan Time (Defined by the TRA)

a. If the RETURN flag is 0 (zero) and the modulus of the new OP subtracted from the stored OPC is greater than D, the compensator updates the OPC value (updates the stored value) to the OP value and sends it to the actuator.
b. If the RETURN flag is 0 (zero) and the modulus of the new OP subtracted from the stored OPC is greater than 0 (zero) but less than BOP, the compensator maintains the stored OPC value and sends it again to the actuator.
c. If the RETURN flag is 0 and the modulus of the new OP subtracted from the stored OPC is greater than BOP and less than D, the compensator updates the OPC value to the current OP value plus D and changes the value of the RETURN auxiliary flag to 1 (one).
d. If the RETURN flag is equal to 1 (one), the OPC value is updated to its own stored value subtracted from the D value multiplied by FA, and the RETURN value is updated to 0 (zero).

### 5. Value Checking

a. The current OPC value to be sent to the actuator is checked for values less than 0 and greater than 100 (the signal to the actuator is the movement percentage, range 0 to 100%).
b. If OPC<0, OPC is reset to 0 (zero).
c. If OPC>100, OPC is reset to 100 (one hundred).

### 6. Tracking

a. If the compensator is turned off, the compensator block resets the RETURN value to 0 (zero) and copies the OP value to OPC (this is done to prevent the stored OPC from differing from the OP when the compensator is turned on).

### 7. Sending The OPC Value to the Actuator

a. If the compensator is activated, the current stored OPC value is sent to the actuator at each sampling time defined by the TRA.
b. If the compensator is turned off, the OP signal generated by the controller is bypassed by the compensator and sent directly to the actuator at each sampling time of the controller.

It is worth noting that, if the actuator is a control valve, which is the most common control element in the industry, the seizure D, the BOP and actuator movements will be defined as a function of the valve stem position, that is, D, BOP and OPC are defined as a % of control valve stem movement.

The present invention also provides for a system, as seen in FIG. 3, comprising a controller (Gc), a compensator (G_comp) and a process that has an actuator, in which the compensator (G_comp) is configured to perform the steps defined above.

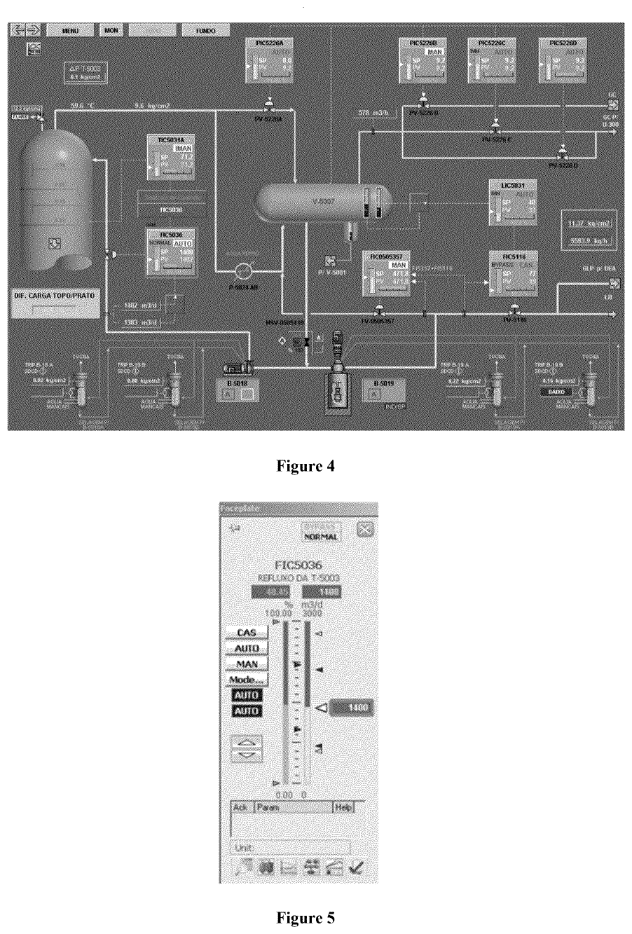

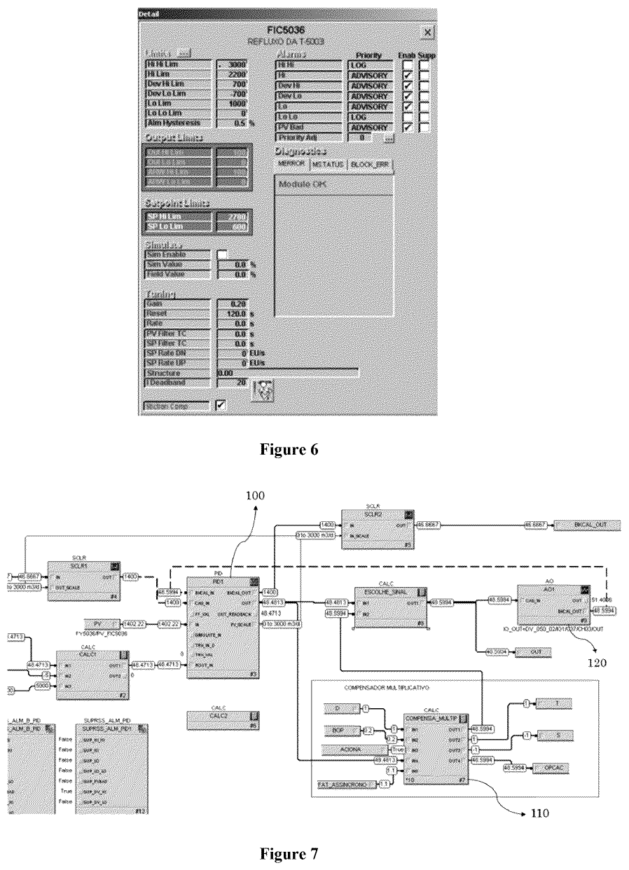

In validating the method described above, a compensator was implemented in a naphtha reflux flow control loop (FIC-5036) directly in the control system, in this case an Emerson Inc. Distributed Control System (SDCD), as can be seen in the operating screen shown in FIG. 4. The faceplate—individual operating panel of the loop, normally showing the values of the process variables and output of the FIC-5036 controller is shown in FIG. 5. The detail faceplate—panel where details of the loop configuration are indicated-with the option to use the compensator activated is shown in FIG. 6. When selecting the “stiction_comp” option, the control loop starts to operate with the compensator.

FIG. 7 shows the FIC-5036 loop module in effect at the plant, where it can be seen that the controller output, PID1 block (100), is sent to the compensator block (110) and then to the physical element block (120) that is connected to an actuator at the plant. Note that the parameters in FIG. 2 are input values from the compensator module, namely: D (40), BOP (30), FAT_ASSYNCRONO (60). TRA (50) is an internal parameter of the calculation block and does not appear in this figure.

Regarding the results obtained, the previous situation (without the compensator) and the current situation (with the compensator) will be shown, both for the same time horizon.

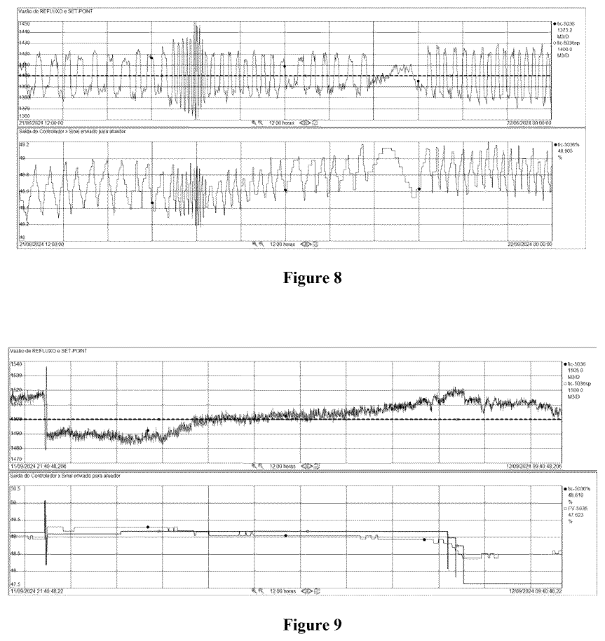

FIG. 8 shows the behavior of the FIC-5036, with the top graph referring to the controlled variable and the bottom graph referring to the controller output being sent directly to the actuator. In this figure, it can be seen that the oscillatory and undesirable behavior of FIG. 1 occurs.

FIG. 9 shows the behavior of the FIC-5036, with the top graph referring to the controlled variable and the bottom graph referring to the controller output and the signal sent to the actuator after being processed by the compensator (blue line). Note that the oscillation ceases and the movement in FIG. 2 occurs at times along the blue line. Note that the controller output becomes much less aggressive. As for the controlled variable, it exhibits a small deviation from the desired value. However, this deviation is much smaller than the situation in FIG. 8, and there is no oscillation, which is undesirable because it disrupts the industrial plant and, also, reduces the lifespan of the actuator.

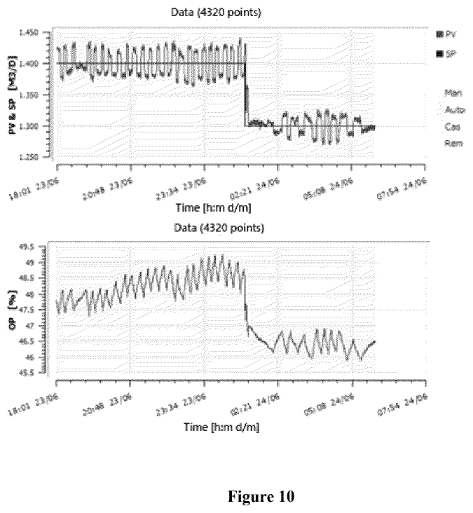

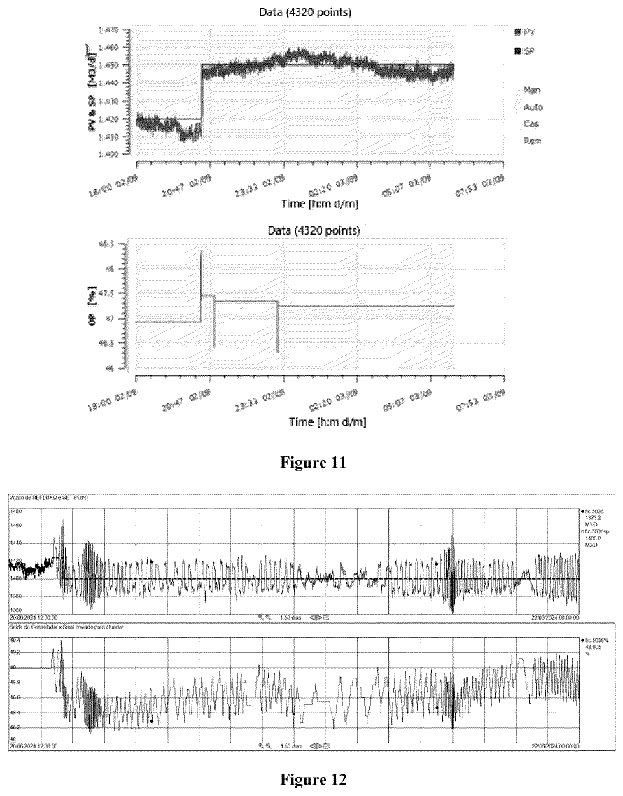

FIG. 10 shows data from a Control Loop Performance Monitor (CLPM) tool for the loop operating without the compensator. In this figure, the graph below shows the controller output being sent directly to the actuator. FIG. 11 shows data from the same CLPM tool operating with the compensator for the same time horizon and, also, with a set-point change. In this figure, the graph below shows the signal actually sent to the actuator after passing through the compensator. It can be seen that the oscillations disappear in FIG. 11, and the excursion (also known as modulation, travel, or actuator movement) of the actuator is reduced by more than 90% of its usual value without the static friction compensator. Only a few minor adjustments were made to return the controlled variable to the desired value.

### Advantages of the Disclosure

Process control is the first layer of process safety. It is responsible for keeping variables within safe values to avoid operational contingencies. If a control loop has a relatively large seizure and operates automatically, this leads to a loss of performance of the controlled variable and, also, leads to a reduction in the lifespan of the actuator, which is actuated in a gratuitous/useless oscillatory motion. This can be seen in FIG. 12, for the same loop used in the validation above (FIC-5036), over a 2-day horizon.

Often, the oscillation is so great that the operator chooses to remove the loop from automatic mode and operate the actuator in manual mode. In this case, the safety barrier is degraded and the unit loses reliability, as the human operator is unable to operate 24 hours a day to keep the controlled variable within safe limits. Therefore, control loops with seizure represent a loss of performance, a reduction in actuator lifespan, and a degradation in industrial plant safety.

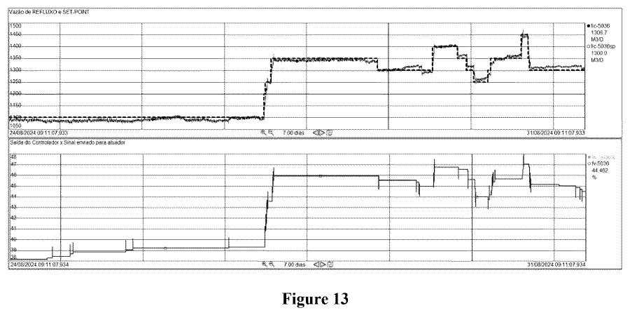

The compensation method of the present invention makes it possible to operate the loop in automatic mode, avoiding degradation of the safety of the unit and greatly increasing the service life of the actuator. This can be seen in FIG. 13, for a longer time horizon (one week). Advantageously, control is performed without oscillations and with minimal actuator movement. Compared to the knocker, the present method causes much less damage to the actuator, which can be easily confirmed by observing the behavior of the knocker reported in open publications by its authors, which constantly adds pulses, with the compensation method being proposed, which performs two movements only when necessary. Quantitatively, it can be stated that the reduction in movements is at least two orders of magnitude, that is, one hundred times fewer movements than a loop without the compensator or operating with the knocker. This represents something truly disruptive, as the control is better, even with much less movement of the actuator.

It is important to highlight two innovations proposed here that are absent in other methods: TRA (actuator response time) and FA (asymmetric factor), as shown in FIG. 2. By implementing TRA, the invention allows the actuator time to reach the position transmitted by the compensator. If this is not achieved, the signal transmitted may change faster than the actual positioning time of the actuator. This is a characteristic of each actuator and needs to be adjusted for each control loop, although a typical value of 3 to 10 seconds is acceptable. On the other hand, implementing FA ensures that the return position overcomes static friction (D) and moves the actuator to control the process variable until it reaches a position where the BOP prevents its oscillation. Upon overcoming the BOP, the compensator adds this value to the value of D (estimated grip) and moves the actuator. A symmetrical movement of D, as already known in the prior art, while desirable to maintain the control signal, may not be sufficient to move the actuator upon return. A value of around 10% for the FA proved sufficient to balance position return with guaranteed actuator movement.

In summary, the proposed method allows a control loop to operate automatically and stably even in the presence of valve seizure, while also greatly increasing the service life of the actuator. The compensator can be programmed using the method being described directly in DCSs or other control systems and has the potential to become a commercially available module for major control system manufacturers.

The present invention can be applied to all control loops whose quantization (operation at discrete levels, which is the result of excessive static friction) results in unit oscillation.

Although aspects of the present disclosure may be susceptible to several modifications and alternative forms, specific embodiments have been shown by way of example in the drawings and have been described in detail herein. But it should be understood that the invention is not intended to be limited to the particular forms disclosed. Rather, the invention is intended to cover all modifications, equivalents, and alternatives that fall within the scope of the invention as defined by the following appended claims.

1. An asymmetric method for compensating quantizations of control loop actuators, wherein a loop comprises a controller (Gc), a compensator (G_comp), and a process containing an actuator (Gp), the method comprising:
a) if it is a first sampling time, defined by a moment the compensator is activated, recording a current value of a controller output (OP) at a compensator output (OPC), sending this value to the actuator, and setting RETURN to zero;
b) from a second sampling time, defined by an actuator response time (TRA), repeating sequential steps below while the compensator is activated:
if RETURN is zero and a modulus of (OPC-OP) is greater than a predefined seizure (D), the compensator updates the recorded OPC value to the OP value and sends it to the actuator; or
if RETURN is zero and the modulus of (OPC-OP) is greater than zero but less than a predefined BOP, the compensator maintains the recorded OPC value and sends it to the actuator; or
if RETURN is zero and the modulus of (OPC-OP) is greater than BOP and less than D, the compensator updates the recorded OPC value to the current OP value plus D and sets RETURN to one;
if RETURN is equal to one, the OPC value is updated to its own value (OPC-D) multiplied by a predefined asymmetry factor (FA), and the RETURN value is updated to zero.

2. The method of claim 1, further comprising:
before sending the OPC signal to the actuator, checking the current OPC value:
if OPC<0, OPC is reset to zero;
if OPC>100, OPC is reset to one hundred.

3. The method of claim 1, further comprising
if it is detected that the compensator has been disconnected, reset RETURN to zero and reset OPC to the same value as OP.

4. The method of claim 1, wherein FA is a value between 1.05 and 1.25.

5. A loop control system comprising a controller (Gc), a compensator (G_comp), and a process containing an actuator (Gp), wherein the compensator (G_comp) is configured to perform the method of claim 1.

6. The loop control system of claim 5, wherein the actuator contained in the process (Gp) is a control valve.
